(19) United States
(12) Patent Application Publication
(10) Pub. No.: US 2021/0268322 A1
(43) Pub. Date: Sep. 2, 2021

(54) Dry Pipe Fire Protection System Air Maintenance Device with Pressure Monitor

(71) Applicant: South-Tek Systems, LLC, Wilmington, NC (US)

(72) Inventors: Matt Thomas, Wilmington, NC (US); Tracy Dusek, Amery, WI (US)

(21) Appl. No.: 16/806,066

(22) Filed: Mar. 2, 2020

(51) Int. Cl. A62C 35/68; A62C 35/62; A62C 35/64

(52) U.S. Cl. CPC A62C 35/68; A62C 35/645; A62C 35/62

(57) ABSTRACT

An air maintenance device for a dry pipe Fire Protection System (FPS) is capable of measuring an FPS piping network pressure leak rate. The air maintenance device includes a normally-open solenoid isolating it from all gas sources, and a pressure sensor in gas flow communication with the FPS piping network. An electronics module initiates a pressure leak rate measurement operation by reading the pressure sensor, and closing the solenoid, at the beginning of a predetermined duration. At the expiration of the predetermined duration at least a final pressure reading is taken, and the solenoid is opened. A FPS piping network pressure leak rate is calculated by subtracting the final pressure reading from the initial pressure reading, and dividing by the predetermined duration. If intermediate readings indicate a pressure below a threshold, the measurement is aborted and the solenoid is opened to allow the gas sources to maintain system pressure.

### FIELD OF INVENTION

The present invention relates generally to Fire Protection Systems, and in particular to an Air Maintenance Device for a dry pipe FPS that monitors the FPS pressure leak rate.

### BACKGROUND

A typical Fire Protection System (FPS), colloquially called a “sprinkler,” such as found in most buildings, is known in the art as a “wet pipe” system. It is filled with water under pressure. Heat from a fire will melt a fusible element in one or more sprinkler head valves, which will open and discharge water. A deflector sends the water out in a spray pattern to maximize coverage area.

In areas that can freeze (e.g., parking garage) or over sensitive equipment (e.g., data center), where leaks would be costly, a “dry pipe” type of system is used. Pressurized water is held back at the building entrance by a water valve known as a clapper valve. The clapper valve is held closed by pressurized gas, referred to as a supervisory gas, in the sprinkler system piping. The supervisory gas is maintained at a gas pressure, referred to as the supervisory pressure, which exceeds the water pressure behind the clapper valve. When a sprinkler head opens due to fire, gas pressure rapidly drops, the clapper valve opens, and water floods the pipes and exits the open sprinkler head(s). The National Fire Protection Association (NFPA) code (25 is the current version) specifies a minimum delay from sprinkler head opening until water discharge.

Traditionally, the supervisory gas has been compressed air from a common air compressor. Most modern dry pipe FPSs use high-purity nitrogen gas, which has a lower dew point, so water does not condensate within the pipes and require draining. Also, the lack of oxygen mitigates rust and corrosion. In either case, a pressure sensor (which may be included in the gas source or added elsewhere in the system) monitors the system pressure, and in response, the source will turn on and off as required to maintain at least a predetermined supervisory pressure in the FPS pipes (some pipe fittings invariably leak, hence requiring active pressure monitoring).

There are competing needs for both high and low gas flow rates into the FPS piping network. When placing a dry pipe FPS into service (e.g., after a test), NFPA 25 specifies a minimum time to bring the FPS up to pressure. Hence, a high gas flow rate is needed. A sprinkler head opening due to a fire is different—in that case, a high gas flow rate entering the FPS piping network would slow down the inflow of water, and hence a low gas flow rate is required after the system is tripped.

FIG. 1 depicts an Air Maintenance Device (AMD) 10 for a dry pipe FPS. An AMD 10 is a device that is interposed between a pressurized gas source and the FPS piping. The pressurized gas source comprises at least an air compressor 12. In FPS systems that operate with air as a supervisory gas, the air compressor 12 is the only gas source. In FPS systems using nitrogen as a supervisory gas, the air compressor 12 feeds compressed air into a nitrogen gas generator 14, which separates nitrogen molecules in the air (about 78%) from oxygen (21%). Optionally, a nitrogen storage tank 16 may store a volume of nitrogen gas under pressure. In any configuration, the gas source 12, 14, 16 includes a pressure sensor, and operates to maintain gas pressure in the FPS piping network at or above the supervisory pressure.

The AMD 10 is a mechanical system of pipes, with a maintenance path 18 and a quick-fill path 20. The quick-fill path 20 is selected, for example, by opening valve 22 and closing valves 24 and 26. The quick-fill path 20 is used to initially bring the FPS system up to supervisory pressure, within the minimum duration specified by the relevant code (i.e., NFPA 25 or 13). This initial fill is typically done with compressed air, even in systems that use nitrogen gas as a long-term supervisory gas, to avoid the need to size the nitrogen generator 14 to provide the very high flow rate required for initial fill.

Once the FPS is at or above supervisory pressure, the quick-fill path 20 is closed, and the maintenance path 18 is opened, for example by closing valve 22 and opening valves 24 and 26. The maintenance path 18 includes a restricted orifice 28, which limits the volumetric flow rate of gas into the FPS pipes. The restricted orifice 28 ensures a low gas flow rate in the event a sprinkler head opens due to fire, so that incoming supervisory gas does not impede the flow of water from the clapper valve to the sprinkler head. The gas flow rate through the restricted orifice 28 is sufficient for system pressure maintenance,—that is, replacing gas that leaks from the FPS piping—and for purging—i.e., supplying nitrogen gas as the initial-fill oxygen gas is bled from the piping (while maintaining supervisory pressure) until a target purity of nitrogen gas is reached.

The NFPA 25 code specifies a maximum gas leak for existing dry pipe FPS of 3 psi in 2 hours (or a normalized leak rate of 1.5 psi/hr). For new installations, NFPA 13 specifies the maximum gas leak rate of 1.5 psi in 24 hours. Without special testing, building owners have no way to know if they comply with these code requirements. Although the frequency of a gas source 12, 14, 16 kicking in to maintain minimum pressure may provide a rough indication of the leak rate, such an approximation is insufficient to ensure (and demonstrate) code compliance.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, an air maintenance device is capable of measuring an FPS piping network pressure leak rate. The air maintenance device includes a normally-open solenoid isolating it from all gas sources, and a pressure sensor in gas flow communication with the FPS piping network. An electronics module initiates a pressure leak rate measurement operation by checking the pressure sensor. If the FPS piping network is at a pressure above a first pressure threshold, a controller in the electronics module closes the solenoid to isolate the air maintenance device, and the FPS piping network downstream of it, from the gas sources. At least an initial FPS piping network pressure is read from the pressure sensor. Over a predetermined duration, additional pressure readings are taken. If at any time the FPS piping network drops below the first pressure threshold, the measurement operation is aborted and the solenoid is opened, to allow the gas source to maintain supervisory pressure in the FPS. At the expiration of the predetermined duration at least a final pressure reading is taken, and the solenoid is opened. A FPS piping network pressure leak rate is calculated by subtracting the final pressure reading from the initial pressure reading, and dividing by the predetermined duration. The pressure leak rate may be scaled or translated to a standard format, such as n psi/2 hr, for direct comparison to the NFPA 25 maximum allowable leak rate. The electronics module may store the calculated pressure leak rate, and may output it in a variety of ways.

One embodiment relates to an air maintenance device configured to be interposed between a pressurized gas source and a piping network of a dry pipe fire protection system (FPS). The air maintenance device includes a piping network selectively defining a through path having a restricted orifice and a bypass path; a normally-open solenoid between the through path and a pressurized gas source; a pressure sensor in gas flow communication with the FPS piping network; and a controller. The controller is configured to close the solenoid to selectively isolate the FPS piping network from the pressurized gas source for at least a predetermined duration; read the pressure sensor at least at the beginning and end of a predetermined duration; and calculate and output a pressure leak rate of the FPS piping network.

Another embodiment relates to a method of measuring a pressure leak rate of a dry pipe fire protection system (FPS) having an air maintenance device interposed between a pressurized gas source and a piping network of a FPS. A normally-open solenoid interposed between a through path of the air maintenance device and the pressurized gas source is closed. A pressure sensor in gas flow communication with the FPS piping network is read, at least at the beginning and end of a predetermined duration. A pressure leak rate of the FPS piping network is calculated from at least the two pressure readings and the predetermined duration.

Yet another embodiment relates to a non-transitory, computer-readable storage medium. Stored on the computer-readable storage medium is a computer program product comprising instructions. The instructions are configured to cause a controller in an electronics module of an air maintenance device including a normally-open solenoid and pressure sensor, and interposed between a pressurized gas source and a piping network of a dry pipe fire protection system (FPS), to perform a FPS piping network pressure leak rate measurement. The controller performs the measurement by performing the steps of: closing the normally-open solenoid interposed between a through path of the air maintenance device and the pressurized gas source; reading a pressure sensor in gas flow communication with the FPS piping network at least at the beginning and end of a predetermined duration; and calculating a pressure leak rate of the FPS piping network from at least the two pressure readings and the predetermined duration.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a schematic diagram of a prior art air maintenance device.

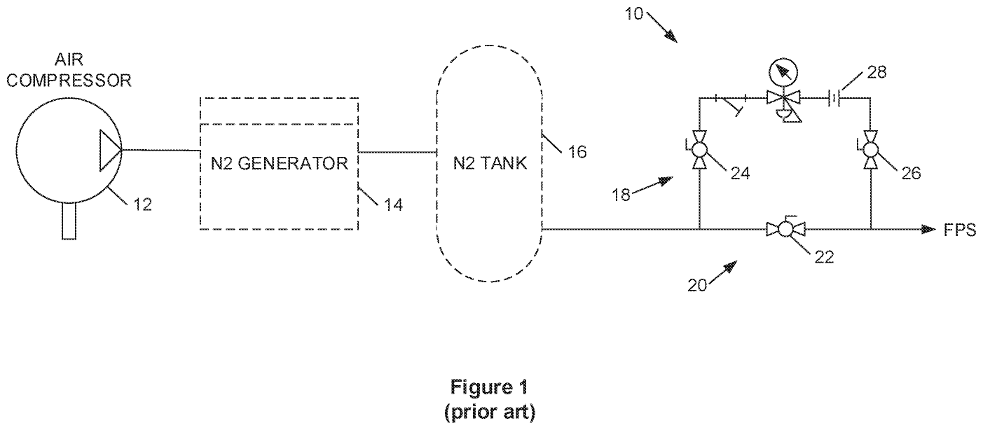

FIG. 2 is a schematic diagram of an air maintenance device according to one embodiment of the present invention.

FIG. 3 is a flow diagram of a method of determining a pressure leak rate of a FPS piping network.

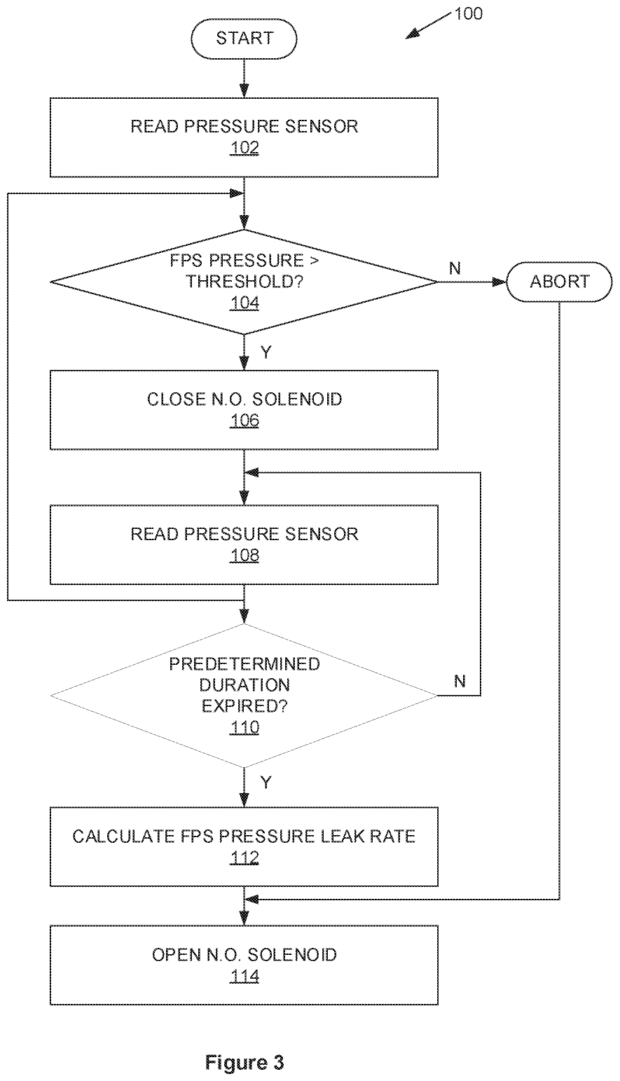

FIG. 4 is a block diagram of an electronics module of the air maintenance device of FIG. 2.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

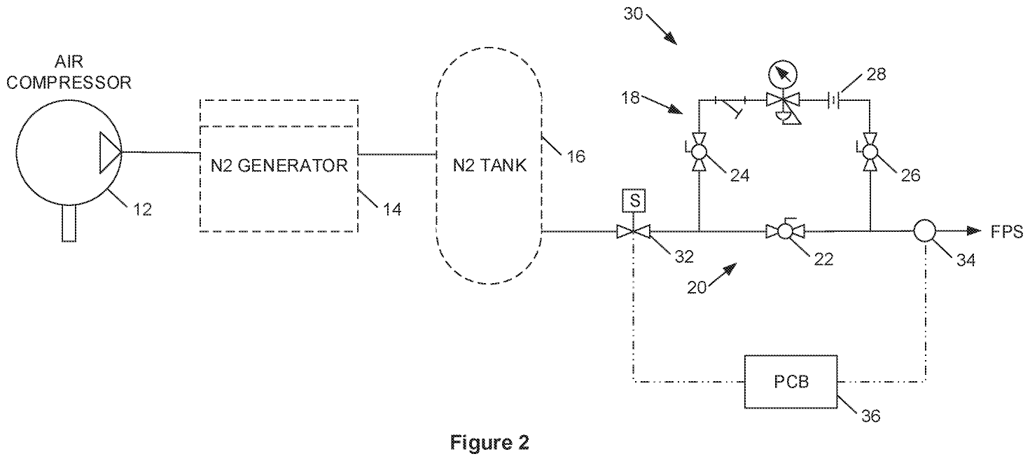

FIG. 2 depicts an AMD 30 according to embodiments of the present invention. The AMD 30 includes the maintenance path 18 with restricted orifice 28, and quick-fill path 20, as described above. The AMD 30 additionally includes a solenoid 32, a pressure sensor 34, and an electronics module 36, such as a Printed Circuit Board (PCB) that controls the solenoid 32 and receives the output of the pressure sensor 34. The dashed-dotted lines connecting the solenoid 32 and pressure sensor 34 to the electronics module 36 indicate electrical connections (note that in some embodiments, one or both of these connections may be wireless).

The solenoid 32 is of the normally-open type, meaning that in a default, or unactuated, state, the solenoid 32 is open and gas may pass freely through it. Accordingly, during normal operation of the FPS, the solenoid 32 does not interfere with the initial air fill, subsequent nitrogen purge, or the replenishment of either source gas as the FPS pipe couplings leak. As described herein, when actuated by an electronic signal, the solenoid 32 closes to prohibit the flow of any source gas into the AMD 30 (and hence into the FPS piping network), so as to isolate the FPS piping network pressure from outside influence. For safety and a fail-safe operation, the solenoid is preferably of the normally-open type, which closes to isolate the air maintenance device 30 and FPS piping network from gas sources 12, 14, 16 only when the controller 38 supplies an active signal to do so. At all other times (and, for example, if the electronics module 36 were to fail, lose power, or otherwise become inoperative) the solenoid 32 remains open, so as to allow the gas source 12, 14, 16 to maintain supervisory pressure in the FPS piping network, preventing the inadvertent actuation of the clapper valve if FPS piping network pressure were to fall below supervisory pressure level. A suitable solenoid 32 is model 8210G012 available from Asco of Florham Park, N.J.

The pressure sensor 34 is in gas flow communication with the FPS piping network, whether the AMD 30 is in maintenance mode or quick-fill mode. Accordingly, the pressure sensor 34 measures the pressure in the FPS piping network. In one embodiment, as depicted in FIG. 2, the pressure sensor 34 is embedded in the piping network of the AMD 30, with a wired or wireless electronic connection to the electronics module 36. A suitable pressure sensor 34 for this embodiment is model MSP300 available from TE Connectivity of Schaffhausen, Switzerland. In another embodiment, the pressure sensor 34 is mounted on the electronics module 36, which may for example comprise a printed circuit board. In this embodiment (not shown), a tube, piping, or other passage connects at least the pressure sensor 34 in gas flow communication with the AMD 30 piping (and hence with the FPS piping network).

The electronics module 36 outputs a control signal to the solenoid 32, and receives the output from the pressure sensor 34, indicative of FPS piping pressure. As those of skill in the art are aware, the electronics module 36 requires a source of power, which may for example comprise a battery, standard AC power (e.g., 110V, 60 Hz AC power), or the like. A power supply may condition the source power to the voltage and current required for electronic components in the electronics module 36. In one embodiment, the electronics module 36 also includes a wired or wireless data communication interface to a remote computer (not shown), for example executing a Building Maintenance System (BMS), which may control lighting, HVAC, access/security, fire alarm, and the like. The data communication interface may be bidirectional, in which case the electronics module 36 operates under the control of the remote computer. Alternatively, the electronics module 36 may operate autonomously, and output a pressure loss rate, alarm, or the like to the remote computer. In one embodiment, the electronics module 36 also receives operating power in a standard format, such as 24 VDC, at the BMS interface; in this embodiment, a separate power supply on the electronics module 36 may not be necessary.

In operation, when the AMD 30 is in maintenance mode, the electronics module 36—either autonomously (e.g., on a timer) or under the control of a remote computer—initiates an FPS piping pressure measurement cycle. The electronics module 36 initially closes the solenoid 32. This isolates the FPS piping network from all gas source equipment 12, 14, 16. The electronics module 36 then monitors the pressure sensor 34 output over a predetermined duration. The electronics module 36 may monitor and record (e.g., in memory) the FPS piping pressure periodically, such as every minute. At the conclusion of the predetermined duration, the change in pressure sensor 34 outputs, divided by the duration, and adjusted to a standard form, such as psi/hr, is stored or output as the FPS piping network pressure leak rate. For example, if the pressure sensor 34 output drops from 36 psi to 34.8 psi over one hour, the leak rate is 1.2 psi/hr—within the NFPA 25 limit of 3 psi/2 hr. Of course, the pressure measurements need not be taken over one hour duration; any monitoring period will suffice, so long as it is sufficiently long to capture a statistically significant change in FPS pressure. The observed pressure leak rate can be converted to any standard format—such as psi/2 hr, for easy comparison to the NFPA 25 or NFPA 13 code. After the predetermined pressure monitoring duration, the electronics module 36 removes the actuation signal from the solenoid 32, which then opens and normal pressure maintenance and N2 purging operations continue.

The electronics module 36 may store a list of FPS pressure leak rates detected in successive leak rate monitoring operations. The electronics module 36 may also keep a running average of the FPS pressure leak rate, based on the latest n stored FPS pressure leak rates. The electronics module 36 may display the FPS pressure leak rate, such as via an LCD display or the like. The electronics module 36 may also report the measured FPS pressure leak rate to the BMS at the conclusion of every leak rate monitoring operation, or when queried for the number by the BMS. If the measured FPS pressure leak rate is below a predetermined threshold, such as the relevant NFPA 25 or NFPA 13 specification, the electronics module 36 may also issue an alarm, such as by lighting a continuous or flashing light, emitting an audible alarm, or the like.

In one embodiment, the electronics module 36 initially reads the pressure sensor 34 output prior to closing the solenoid 32. The leak rate monitoring process then proceeds only if the FPS piping network pressure is above a predetermined setpoint.

In one embodiment, if at any time during the leak rate monitoring process, FPS piping network pressure falls below a predetermined threshold, the electronics module 36 aborts the leak rate monitoring process and opens the solenoid 32, to avoid actuating the FPS due to low FPS piping pressure. The gas source(s) 12, 14, 16 will then operate to restore FPS piping pressure to its supervisory pressure.

FIG. 2 depicts the steps in a method 100 of measuring a pressure leak rate of a dry pipe FPS having an inventive air maintenance device 30 interposed between a pressurized gas source 12, 14, 16 and the piping network of the FPS. Initially, upon beginning a FPS piping network pressure leak rate measurement, the electronics module 36 obtains a reading from the pressure sensor 34 (block 102), and compares the FPS pressure to a first pressure threshold (block 104). If the FPS pressure is below the first pressure threshold, the pressure leak rate measurement process is aborted. The first pressure threshold may, for example, be set to a value greater than the supervisory pressure. If the FPS pressure is above the first pressure threshold (block 104), the electronics module 36 closes the solenoid 32 (block 106), isolating the air maintenance device 30, and the entire downstream FPS piping network, from all gas sources 12, 14, 16. This isolates the FPS piping network from any possible change in pressure, which may for example occur if a gas source 12, 14, 16 were to “kick in” due to FPS pressure being at or near the minimum supervisory pressure.

With the air maintenance device 30 and FPS piping network isolated, an initial output of the pressure sensor 34 is read (block 108) and stored in memory. A predetermined pressure leak rate measurement duration is begun, such as by starting a count-down timer initialized to a predetermined value. Periodically, or in some embodiments, continuously, as long as the predetermined duration has not expired (block 110), additional pressure readings are taken from the pressure sensor 34. In one embodiment, each of these is compared to the first pressure threshold (block 104). If the FPS piping network pressure falls below the first pressure threshold at any time during the predetermined duration, the pressure leak rate measurement operation is aborted, and the solenoid 32 is opened (block 114), allowing normal operation of the gas source(s) 12, 14, 16 to replenish FPS pressure. If the intermediate pressure readings are above the first pressure threshold (block 104), the measurement operation continues (the solenoid 32 remains closed at block 106) by periodically or continuously obtaining another pressure reading (block 108).

At the expiration of the predetermined duration (block 110), the electronics module 36 calculates the FPS pressure leak rate (block 112). For example, the electronics module 36 may subtract the last pressure reading from the first pressure reading, and divide by the predetermined duration. The FPS pressure leak rate can then be scaled to conform to any desired or required format (e.g., n psi/2 hr). Finally, the electronics module 36 opens the solenoid 32 (block 114), allowing normal operation of the gas sources 12, 14, 16 to maintain FPS pressure at or above supervisory pressure.

The calculated FPS piping network pressure leak rate may be stored locally by the electronics module 36. Using prior, stored FPS pressure leak rate values (e.g., obtained in previously executed FPS pressure leak rate measurement operations 100), a running average FPS pressure leak rate may be updated. The calculated FPS pressure leak rate, or the updated running average FPS pressure leak rate, may be output, such as via a wired or wireless link to a remote computer running Building Maintenance System software, or by displaying on a local display, such as an LCD screen. If the calculated FPS pressure leak rate is greater than a predetermined pressure leak rate threshold (e.g., the NFPA 25 or 13 specification of 3 psi/2 hr or 1½ psi/24 hr), the electronics module 36 may emit an alarm, which may for example comprise a warning output to a screen, a flashing light or LED, a buzzer or other audible alarm, or the like.

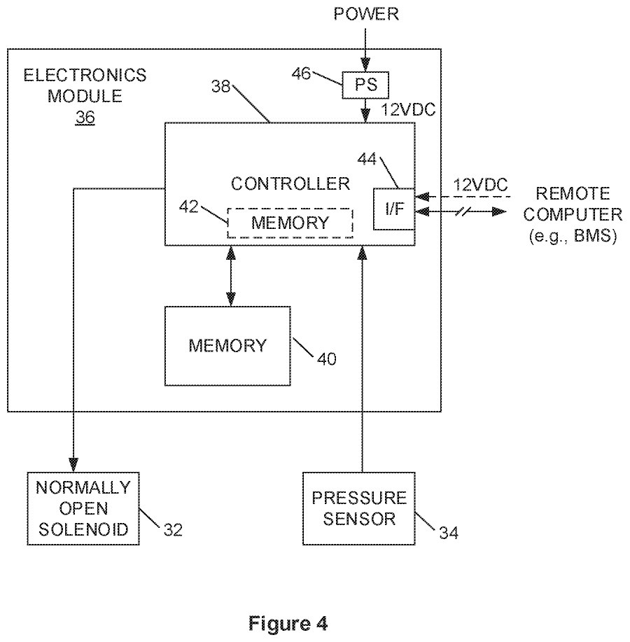

FIG. 4 is a block diagram of one embodiment of the electronics module 36. The electronics module 36 includes a controller 38, memory 40, and a power supply 46. The electronics module 36 may be implemented on a circuit board, such as printed circuit board. Alternatively, the electronics module 36 may be implemented in a single integrated circuit, such as an FPGA, ASIC, or the like. The power supply 46 is operative to receive external power, such as DC power from a battery, AC power from a wall socket, or the like, and condition to power to a voltage and form suitable for circuitry on the electronics module 36. For example, as shown, the power supply 46 may generate and distribute a regulated 12 VDC power to all relevant circuit components. Of course, 12 VDC is exemplary only; the power supply 46 may generate a regulated 5V, 3.3V, or any other value of supply voltage.

The controller 38 may comprise a sequential state machine operative to execute machine instructions stored as machine-readable computer programs in the memory 40, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above. A suitable controller 38 is model Twix-2-24VDC available from Selec Controls PVT LTD. of Navi Mumbai, India. In one embodiment, the controller 38 is connected to external memory 40. According to embodiments of the present invention, the memory 40 is configured to store, and the controller 38 is configured to execute, software comprising instructions which when executed are operative to cause the electronics module 36 to execute the method 100 described herein. The memory 40 may comprise any non-transitory machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like. The memory 40 may be external to the controller 38, as shown. In another embodiment, the controller 38 may include sufficient internal memory 42 (e.g., organized as register files, cache memory, ROM, general-purpose memory, or the like) to execute the method 100 without the need for external memory 40.

In one embodiment, the controller 38 includes, or implements, an interface 44 configured to exchange data with a remote computer, such as a computer executing a Building Maintenance System program. In particular, the controller 38 is configured to at least transmit to the remote computer a calculated FPS piping network pressure leak rate. In one embodiment, the controller 38 also receives data from the remote computer, such as a command to initiate a new FPS piping network pressure leak rate measurement operation (e.g., by executing the method 100 described herein). In one embodiment, the electronics module 36 receives suitable power, such as for example 12 VDC, from the remote computer. In this case, the power supply 46 may not be necessary and may be omitted.

As shown, and as described herein, the controller 38 receives output from at least one pressure sensor 34, and outputs control signals to at least one solenoid 32. Either or both signals may be wired or wireless connections, with appropriate transducers at either end in the case of wireless connection. Although only one solenoid 32 and one pressure sensor 34 are depicted, embodiments of the present invention are not so limited. For example, the electronics module 36 may receive outputs from pressure sensors 34 in different parts, or zones, of the FPS piping network, and may control solenoids 32 positioned within the FPS piping network to isolate such parts or zones for FPS pressure leak rate measurement.

As used herein, the term “configured to” means set up, organized, adapted, or arranged to operate in a particular way; the term is synonymous with “designed to.”

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. An air maintenance device configured to be interposed between a pressurized gas source and a piping network of a dry pipe fire protection system (FPS), comprising:
a piping network selectively defining a maintenance path having a restricted orifice and a quick-fill path;
a normally-open solenoid between the FPS piping network and a pressurized gas source;
a pressure sensor in gas flow communication with the FPS piping network; and
a controller configured to
close the solenoid to selectively isolate the FPS piping network from the pressurized gas source for at least a predetermined duration;
read the pressure sensor at least at the beginning and end of a predetermined duration; and
calculate and output a pressure leak rate of the FPS piping network.

2. The device of claim 1 wherein the pressure sensor is disposed within the piping network.

3. The device of claim 1 wherein the controller and pressure sensor are disposed on a circuit board, and wherein a passage connects the pressure sensor in gas flow communication with the FPS piping network.

4. The device of claim 3 wherein the circuit board includes an interface to a remote computer.

5. The device of claim 1 wherein the controller is further configured to, prior to closing the solenoid:
read the pressure sensor; and
if the FPS piping network pressure is below a first pressure threshold, abort the pressure leak rate measurement process.

6. The device of claim 1 wherein the controller is further configured to, after closing the solenoid:
monitor the pressure sensor at least periodically; and
if the FPS piping network pressure is below a first pressure threshold, abort the pressure leak rate measurement process and open the solenoid.

7. The device of claim 1 wherein the controller is further configured to output an alarm if the pressure leak rate of the FPS piping network is above a predetermined leak rate threshold.

8. The device of claim 1 wherein the controller is further configured to store the calculated pressure leak rate of the FPS piping network.

9. The device of claim 8 wherein the controller is further configured to calculate a running average pressure leak rate of the FPS piping network over a plurality of FPS pressure leak rate measurement operations.

10. A method of measuring a pressure leak rate of a dry pipe fire protection system (FPS) having an air maintenance device interposed between a pressurized gas source and a piping network of a FPS, comprising:
closing a normally-open solenoid interposed between the FPS piping network and the pressurized gas source;
reading a pressure sensor in gas flow communication with the FPS piping network at least at the beginning and end of a predetermined duration; and
calculating a pressure leak rate of the FPS piping network from at least the two pressure readings and the predetermined duration.

11. The method of claim 10 wherein reading a pressure sensor in gas flow communication with the FPS piping network comprises reading a pressure sensor disposed within piping of the air maintenance device downstream of the solenoid.

12. The method of claim 10 wherein reading a pressure sensor in gas flow communication with the FPS piping network comprises reading a pressure sensor disposed on a circuit board and in gas flow communication with the FPS piping network via an air passage.

13. The method of claim 10 further comprising communicating the calculated pressure leak rate of the FPS piping network with a remote computer.

14. The method of claim 10 further comprising, prior to closing the solenoid:
reading the pressure sensor; and
if the FPS piping network pressure is below a first pressure threshold, aborting the pressure leak rate measurement process.

15. The method of claim 10 further comprising, after closing the solenoid:
monitoring the pressure sensor at least periodically; and
if the FPS piping network pressure is below a first pressure threshold, aborting the pressure leak rate measurement process and opening the solenoid.

16. The method of claim 10 further comprising outputting an alarm if the pressure leak rate of the FPS piping network is above a predetermined leak rate threshold.

17. The method of claim 10 further comprising storing the calculated pressure leak rate of the FPS piping network.

18. The method of claim 17 further comprising calculating a running average pressure leak rate of the FPS piping network over a plurality of FPS pressure leak rate measurement operations.

19. A non-transitory, computer-readable storage medium having stored thereon a computer program product comprising instructions configured to cause a controller in an electronics module of an air maintenance device including a normally-open solenoid and pressure sensor, and interposed between a pressurized gas source and a piping network of a dry pipe fire protection system (FPS), to perform a FPS piping network pressure leak rate measurement by performing the steps of:
closing the normally-open solenoid interposed between the FPS piping network and the pressurized gas source;
reading a pressure sensor in gas flow communication with the FPS piping network at least at the beginning and end of a predetermined duration; and
calculating a pressure leak rate of the FPS piping network from at least the two pressure readings and the predetermined duration.

20. The computer-readable storage medium of claim 19 wherein the instructions are further configured to cause the controller to, prior to closing the solenoid:
read the pressure sensor; and
if the FPS piping network pressure is below a first pressure threshold, abort the pressure leak rate measurement process.

21. The computer-readable storage medium of claim 19 wherein the instructions are further configured to cause the controller to, after closing the solenoid:
monitor the pressure sensor at least periodically; and
if the FPS piping network pressure is below a first pressure threshold, abort the pressure leak rate measurement process and open the solenoid.
